(19) United States
(12) Patent Application Publication
(10) Pub. No.: US 2010/0192435 A1
(43) Pub. Date: Aug. 5, 2010

(54) TACTILE SIGN

(75) Inventors: Michael Patrick Miscamble, Queensland (AU); Roger Thompson, Queensland (AU)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: Michael Patrick Miscamble, New Farm, Queensland (AU)

(21) Appl. No.: 12/601,615

(22) PCT Filed: May 26, 2008
(86) PCT No.: PCT/AU2008/000741

§ 371 Date: Dec. 3, 2009

(30) Foreign Application Priority Data
May 24, 2007 (AU) 2007100429

(51) Int. Cl. G09F 7/10; G09B 21/00

(52) U.S. Cl. 40/618; 434/113

(57) ABSTRACT

A tactile sign (30) comprises a baseplate (31), and at least one character tile (32, 33) which is able to be securely mounted on the baseplate (31), wherein the at least one character tile (32,33) includes at least one raised tactile character (34, 35).

### CROSS-REFERENCE TO RELATED APPLICATIONS

This application is a Section 371 of International Application No. PCT/AU2008/000741, filed May 26, 2008, which was published in the English language on Nov. 27, 2008, under International Publication No. WO 2008/141399 A1 and the disclosure of which is incorporated herein by reference.

### BACKGROUND OF THE INVENTION

The present invention relates generally to signs and, in particular, to tactile signs.

Although the present invention will be described with particular reference to a tactile sign for displaying a taxi registration number so that the number can be read by taxi passengers who may or may not be visually impaired, it will be appreciated that the present invention is not limited to such tactile signs, and that it may be used in a variety of situations. For example, it may be used as a language education tool for people who may or may not be visually impaired, or it may be used for the display of numbers such as, for example, door or seat numbers, or for the display of individualized information such as, for example, directory board information.

In Australia, taxi operators are required to display their taxi registration number on their taxi so that it can be read by their passengers. Typically, their registration number must be prominently displayed on a tactile sign which can be readily touched by their passengers so that visually impaired passengers are able to read the sign.

To allow the number to be read by visually impaired and non-visually impaired passengers alike, the registration number is usually displayed on the sign as a series of raised tactile alphanumeric characters and as a series of Braille characters which are located to the left of the alphanumeric characters. Sometimes, the Braille characters are omitted so that the registration number is only displayed on the sign as a series of raised tactile alphanumeric characters.

The Braille characters on many existing tactile taxi registration signs consist of one or more Braille balls which are secured to a support surface of the sign by an adhesive or other securing means. The tactile alphanumeric characters of those signs are secured to the support surface in a similar manner. A problem with securing the Braille and alphanumeric characters to the support surface in this way is that the individual Braille balls and alphanumeric characters tend to detach from the support surface either as a result of general wear and tear, or as a result of vandals deliberately picking or levering the Braille balls or alphanumeric characters off the support surface.

Many existing tactile taxi registration signs are colored so that at least the color of their alphanumeric characters contrasts with that of other parts of the sign. The colors of many existing tactile signs are usually applied by screen printing appropriately colored ink on to the surface of the sign. The quality of ink that is used for this purpose is typically such that the ink tends to fade over time, particularly when exposed to ultraviolet light, and can be scratched off the sign with relative ease. Fading or scratched ink on any sign including a tactile sign can be unsightly, and can, depending upon the extent of fading or scratching, make the sign difficult to read. If the ink becomes too faded or too scratched, it is usually necessary to either apply fresh ink to the sign or to replace the sign with a new one.

Another problem with many existing taxi registration tactile signs is that specialist equipment is required to manufacture them. Consequently, it can be difficult for many users to themselves manufacture the sign or signs that they require because they may not have access to the specialist equipment required for their manufacture.

Also, once they have been made, many existing signs cannot be altered to change the number which they display, so that a completely new tactile sign must be manufactured if the number is changed.

Moreover, with some existing signs, it can be difficult or impossible to properly align the various characters of the sign relative to each other. A sign whose characters are not properly aligned can have an unsightly appearance.

Examples of various prior art signs are disclosed in Australian Patent Nos. 2002301400 and 2002317522, International Patent Application Publication Nos. WO02093348, WO0039403 and WO9429829, French Patent No. 2553551, and U.S. Pat. Nos. 5,504,144, 5,389,413, 5,428,914, 5,389,413, 5,246,757 and 5,246,757.

Examples of known educational products that can be used to enhance learning for both sighted and visually impaired persons can be found at the following Internet websites:

www.jactoys.com.hk/show/educational_1.htm; and
www.tack-tiles.com/index.htm.

### BRIEF SUMMARY OF THE INVENTION

It is an object of the present invention to overcome, or at least ameliorate, one or more of the deficiencies of the prior art mentioned above, or to provide the consumer with a useful or commercial choice.

Other objects and advantages of the present invention will become apparent from the following description, taken in connection with the accompanying illustrations, wherein, by way of illustration and example, a preferred embodiment of the present invention is disclosed.

According to a broad aspect of the present invention there is provided a tactile sign comprising a baseplate, and a character tile which is able to be securely mounted on the baseplate, the character tile including a raised tactile character.

Advantageously, the sign may be assembled by an end user or a sign manufacturer without them having to use specialist equipment.

Preferably, the baseplate includes a recess for receiving the character tile.

Preferably, the character tile also includes a tongue portion, and the baseplate also includes a groove for receiving the tongue portion. Inserting the tongue portion of the character tile into the groove of the baseplate is able to assist in retaining the character tile in the recess.

It is preferred that the character tile includes a locating projection, and that the baseplate includes a character tile locating aperture for receiving the character tile locating projection. By inserting the character tile locating projection into the character tile locating aperture of the baseplate, the character tile is able to be positively located and aligned relative to the baseplate and relative to any other character tiles that may also be received by the recess.

The baseplate may be any suitable size and shape, and may be fabricated from any suitable material or combination of materials. Preferably, the baseplate is fabricated from plastic. In a particular preferred form, the baseplate is molded. For example, the baseplate may be fabricated using a solid plastic injection molding process. Alternatively, the baseplate may be extruded and may be any suitable length. For example, the baseplate may be an extruded aluminum baseplate. The baseplate is preferably flexible or rigid.

It is particularly preferred that the baseplate has two recesses. One of the recesses may receive a character tile which includes a first type of tactile character, and the other recess may receive a character tile which includes a second type of tactile character. For example, one of the recesses may receive a character tile which includes a raised tactile Braille character, and the other recess may receive a character tile which includes a raised tactile alphanumeric character. The recess which may be used for receiving Braille character tiles is preferably located on the left of the recess which may be used for receiving alphanumeric character tiles. The recesses are preferably of different sizes. The recess which may be used for receiving Braille character tiles is preferably narrower than the recess which may be used for receiving alphanumeric character tiles, and is also preferably shorter than the recess which may be used for receiving alphanumeric character tiles. The recesses are preferably separated from each other.

The recess may extend from an end of the baseplate so that the tactile character tile is able to be slideably inserted into and slideably removed from an end of the recess.

The tactile sign may also include a retaining tile which is able to be slideably inserted into the end of the recess to prevent the character tile from falling out of or being removed from the end of the recess. Preferably, the retaining tile includes a tongue portion for insertion into the groove of the baseplate. In a preferred form, the retaining tile includes a retaining tile locating projection, and the baseplate further includes a retaining tile locating aperture for receiving the retaining tile locating projection.

Preferably, the retaining tile locating projection is able to be received by the retaining tile locating aperture such that the retaining tile locating projection and the retaining tile locating aperture mechanically interlock with each other to inhibit removal of the retaining tile from the recess. In a preferred form, the retaining tile locating projection and the retaining tile locating aperture are adapted so that the retaining tile locating projection is able to be released from the retaining tile locating aperture using a suitable tool such as, for example, a screw driver or the like.

The retaining tile locating projection may be any suitable size and shape. Preferably, the retaining tile locating projection is elongate. The retaining tile locating projection may be the same size or shape as the character tile locating projection.

The retaining tile locating aperture may be any suitable size and shape. Preferably, the retaining tile locating aperture is elongate. The retaining tile locating aperture may be the same size or shape as the character tile locating aperture.

The retaining tile may also include an enlarged end portion for abutting against the baseplate. The enlarged end portion is able to limit the amount by which the retaining tile is inserted into the recess of the baseplate.

The retaining tile may be any suitable size and shape, and may be fabricated from any suitable material or combination of materials. Preferably, the retaining tile is fabricated from plastic. In a particular preferred form, the retaining tile is fabricated using a solid plastic injection molding process. The retaining tile is preferably flexible.

It is preferred that the retaining tile is manufactured as a solid one-piece unit. This is particularly advantageous because it is able to simplify the process of manufacturing the retaining tile.

It is also preferred that the retaining tile includes a Braille locator, particularly if the raised tactile character of the character tile is a Braille character.

In a particular preferred form, the baseplate includes a pair of the grooves, and the grooves are preferably located on opposite sides of the recess. It is preferred that each of the grooves extends the length of the recess.

The character tile locating aperture may be any suitable size and shape. For example, the character tile locating aperture may be circular or elongate. Each character tile locating aperture preferably extends all of the way through the baseplate.

The baseplate may be secured relative to a support in any suitable manner. For example, the baseplate may be secured relative to a support surface with double-sided adhesive tape or some other suitable securing means.

The character tile may be any suitable size and shape, and may be fabricated from any suitable material or combination of materials. Preferably, the character tile is fabricated from plastic. In a particular preferred form, the character tile is fabricated using a solid plastic injection molding process. The character tile is preferably flexible.

It is preferred that the character tile is manufactured as a solid one-piece unit. This is particularly advantageous because it is able to simplify the process of manufacturing the character tile. It can also make it more difficult or even impossible for vandals or the like to remove part or all of the tactile character from the character tile because the tactile character is integrally formed with the rest of the character tile.

In one particular preferred embodiment, the character tile includes a main portion and a pair of the tongue portions extending from the main portion. The tongue portions are preferably offset with respect to the main portion. Each of the tongue portions preferably has at least one beveled edge.

The character tile is preferably tapered so as to ensure a precise and flexible fit between the character tile and the baseplate.

The raised tactile character of the character tile may be any desired character or symbol. For example, the raised tactile character may be a Braille character or an alphanumeric character. All alphanumeric and other non-Braille characters are preferably a minimum of 15 mm tall, raised by 1 mm to 1.5 mm, and have rounded edges. In the case of Braille characters, the Braille dots which form the characters are preferably raised by 0.8 mm and have a domed shaped. If the tactile sign includes both Braille and non-Braille characters, it is preferred that the Braille characters are displayed to the left of the other characters. If the tactile sign includes a Braille locator, the locator is preferably 6 mm high, raised by 1 mm, and has rounded edges.

It is preferred that the raised tactile character is molded, co-molded, over-molded or doubled-shot molded with the rest of the character tile. This is preferably done without drilling, engraving, etching, or embossing into the surface of the character tile.

The character tile locating projection may be any suitable size and shape. Preferably, the character tile locating projection has a circular shape.

The tactile sign is preferably colored so that the color of the raised tactile character contrasts with the color of other parts of the character tile. It is particularly preferred that the tactile sign is colored so as to provide high luminance-contrast of the tactile character. If, for example, the tactile sign is for displaying the taxi registration number of a taxi, the colors of the sign may be the same as the company colors of the taxi. The sign may be molded to PMS (Pantone Matching System) colors.

Preferably, the color of the tactile character may be provided by co-molding, over-molding or doubled-shot molding each character in a particular color with the rest of the character tile which has a different color.

Alternatively, the color of the tactile character may be provided by screen printing a suitably colored ink on the surface of the character. Preferably, high quality and UV stable exterior inks are used. The particular printing process which is used may, for example, be a pad printing or a 3D printing process.

The character tile may have any suitable profile. Preferably, the profile of the character tile is such that the character tile cannot fall out of the baseplate once the tactile sign has been assembled.

The character tile may be securely mounted on the baseplate without the need to adhere the tile to the baseplate.

The tactile sign may have a side loading, top loading or rear loading design to ensure that the character tile is secured to the baseplate. In the side loading design, the character tile is able to be mounted on the baseplate by sliding the character tile into the baseplate from a side or end of the baseplate. In the case of the top loading design, the character tile is able to be mounted on the baseplate by placing the character tile directly on top of the baseplate in the desired position. In the rear loading design, the character tile is able to be mounted on the baseplate from the rear of the baseplate.

The tactile sign may be for exterior or interior use. For example, the tactile sign may be mounted in the interior or on the exterior of a vehicle, or it may be mounted on an exterior or an interior wall which does not belong to a vehicle. The tactile sign could, for example, be mounted on a door other than a vehicle door.

The various components of the tactile sign, including the baseplate and the character tile, may be sonically or chemically welded together to fuse the components into a single solid sign.

The tactile sign may be provided to customers as an unassembled kit which includes the baseplate and a range of character tiles which have various alphanumeric, Braille or other raised tactile characters on them. The customer can then select those character tiles which have the tactile characters which they require, and then mount those character tiles themselves on the baseplate to produce the tactile sign which they require.

The baseplate may be able to be cut to any suitable length to fit any number of the character tiles as required by the tactile sign. In this way, customers such as, for example, sign companies or end users, may cut the baseplate to the length that they require for their tactile sign, and then assemble together the various components of the sign themselves.

Where the baseplate includes a plurality of the character tile locating apertures, those apertures may be used as a measure to determine where to cut the baseplate so that it can accommodate the desired number of character tiles for the tactile sign. For example, if a tactile sign requires twenty character tiles that each include a character tile locating projection, and the baseplate includes a plurality of character tile locating apertures, the locating apertures in the baseplate may be used as a guide to position the baseplate correctly in the guillotine, saw or other cutting device so that the baseplate can be cut to the appropriate length to accommodate the twenty character tiles. In particular, the baseplate may be cut to a length which has the required number of character tile locating apertures to accommodate the locating projections of the character tiles.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a perspective view of a tactile sign according to a first preferred embodiment of the present invention;

FIG. 2 is a perspective view of the baseplate which forms part of the tactile sign depicted in FIG. 1;

FIG. 3 is a reverse perspective view of the baseplate depicted in FIG. 2;

FIG. 4 is a front view of the baseplate depicted in FIG. 2;

FIG. 5 is a bottom view of the baseplate depicted in FIG. 4;

FIG. 6 is an end view of the baseplate depicted in FIG. 4;

FIG. 7 is a perspective view of one of the character tiles of the tactile sign depicted in FIG. 1;

FIG. 8 is a front view of the character tile depicted in FIG. 7;

FIG. 9 is an end view of the character tile depicted in FIG. 7;

FIG. 10 is a rear view of the character tile depicted in FIG. 7;

FIG. 11 is a bottom view of the character tile depicted in FIG. 7;

FIG. 12 is a front view of various alphanumeric and Braille character tiles which are able to be mounted on the baseplate depicted in FIG. 2;

FIG. 13 is an exploded perspective view of the tactile sign depicted in FIG. 1;

FIG. 14 is an exploded reverse perspective view of the tactile sign depicted in FIG. 1;

FIG. 15 is a perspective view of a tactile sign according to a second preferred embodiment of the present invention;

FIG. 16 is a front view of a tactile sign according to a third preferred embodiment of the present invention;

FIG. 17 is a front view of the baseplate which forms part of the tactile sign depicted in FIG. 16;

FIG. 18 is a front view of the various alphanumeric and Braille character tiles which form part of the tactile sign depicted in FIG. 16;

FIG. 19 is an exploded bottom elevation of the tactile sign depicted in FIG. 16;

FIG. 20 is a front view of a tactile sign according to a fourth preferred embodiment of the present invention; and

FIG. 21 is a front view of all of the various components of the tactile sign depicted in FIG. 20 when the sign is unassembled.

### DETAILED DESCRIPTION OF THE INVENTION

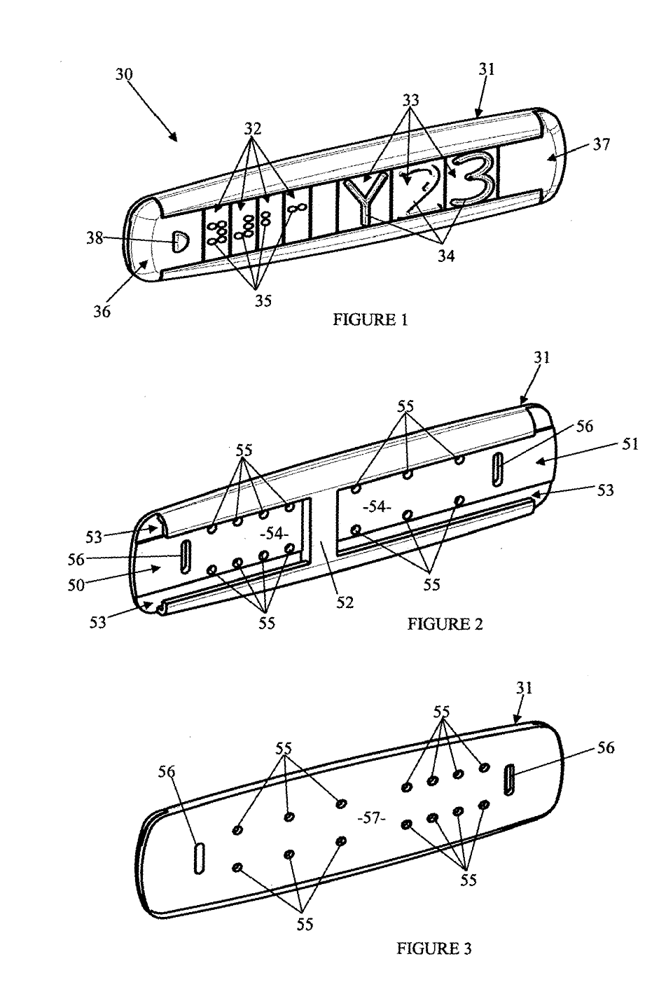

Referring to FIG. 1, a tactile sign 30 according to a first preferred embodiment of the present invention comprises a baseplate 31, and a plurality of character tiles 32, 33 which are securely mounted on the baseplate 31. Each character tile 33 has a respective raised tactile alphanumeric character 34, and each character tile 32 has a respective raised tactile Braille character 35. The Braille characters 35 are equivalent to the alphanumeric characters 34. In particular the leftmost Braille character 35 of the sign 30 corresponds to the alphanumeric character 33 which represents the letter “Y”, the next Braille character 35 is a special character which indicates that the Braille character 35 which follows it is a number, and the last two Braille characters 35 of the sign 30 are the Braille equivalent of the numbers “2” and “3”, respectively.

End retaining tiles 36, 37 are securely mounted on the baseplate 31 at opposite ends thereof. The retaining tiles 36, 37 prevent the character tiles 32, 33 from falling out of the ends of the baseplate 31. The retaining tiles 36, 37 are identical to each other except that the retaining tile 36 has a raised tactile Braille locator 38. The Braille locator 38 signifies that a Braille message follows it.

Except for the raised tactile characters 34, 35 and the Braille locator 38, all other visible surfaces of the tactile sign 30 are smooth and flush with each other. Moreover, there are no gaps between the character tiles 32, 33, retaining tiles 36, 37 and the baseplate 31 so that dirt or other foreign matter cannot collect between those various components. Furthermore, the tactile sign 30 has smooth rounded edges. These features help to make the sign 30 a safe and hygienic tactile sign for use by visually impaired users.

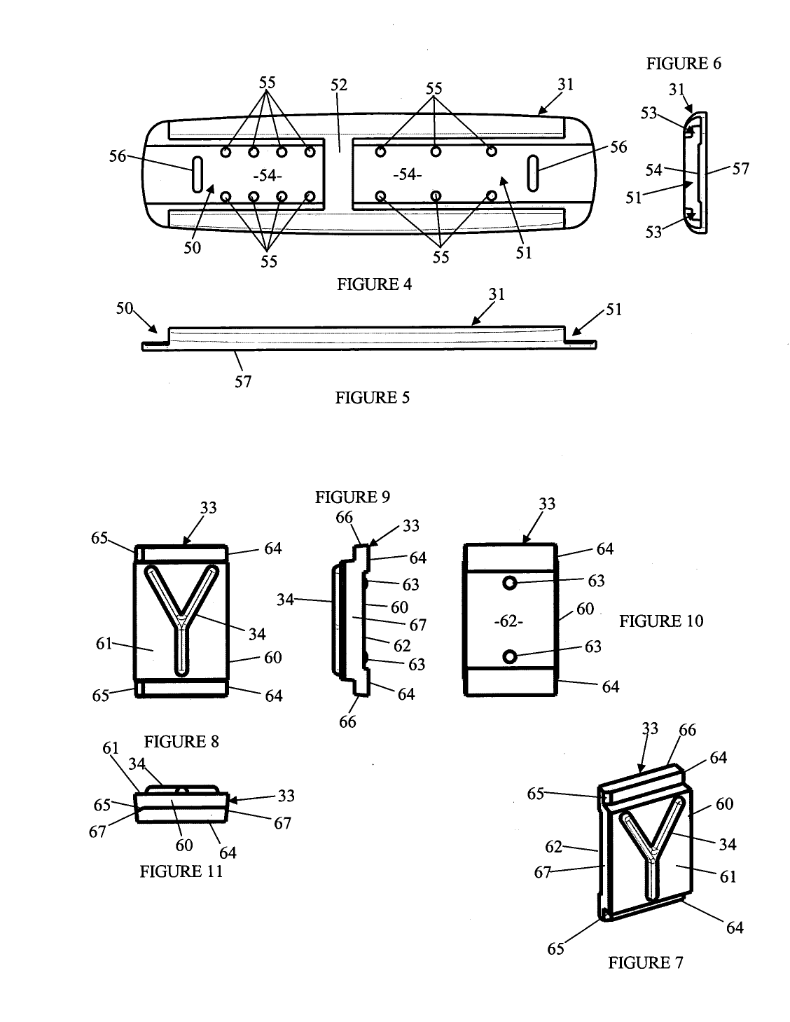

Referring to FIGS. 2 to 5, the baseplate 31 has a first recess 50 located adjacent to the left-hand end of the baseplate 31. In addition, the baseplate 31 has a second recess 51 which is located adjacent to the right-hand end of the baseplate 31, and which is slightly longer than the first recess 50. The first recess 50 and the second recess 51 are separated from each other by a separating portion 52. Both recesses 50, 51 have a pair of grooves 53 which extend lengthwise along opposite sides of the recesses 50, 51. Each recess 50, 51 also has a raised central portion 54 which extends the length of the recess 50, 51. A plurality of circular character tile locating apertures 55, and an elongate retaining tile locating aperture 56 are located in the central portion 54 of each recess 50, 51 and extend through to a flat rear surface 57 of the baseplate 31. The baseplate 31 has rounded edges and is tapered which helps liquid to run-off the baseplate 31.

Referring to FIGS. 7 to 11, each alphanumeric character tile 33 has a main portion 60. The main portion 60 has substantially flat and smooth front and rear surfaces 61, 62. The raised tactile alphanumeric character 34 of each tile 33 extends from the front surface 61, and a pair of circular character tile locating projections 63 extends from the rear surface 62. The Braille characters 35 have a rounded or dome-shaped profile, and the raised tactile alphanumeric characters or symbols 34 have an egg-shaped profile which results in them having a smooth thin ridgeline that can be easily felt by blind or visually impaired users to identify the tactile alphanumeric characters or symbols and distinguish them from the Braille characters 35.

A respective tongue portion 64 extends from the top and bottom of the main portion 60. As can be seen in FIG. 9, the tongue portions 64 are offset with respect to the main portion 60. Each tongue portion 64 has a beveled left-hand end edge 65.

The character tile 33 has sides 66, 67 which are inclined relative to each other so that the tile 33 has a tapered appearance. The taper helps to ensure a precise and flexible fit between the tiles 33 and the baseplate 31.

The Braille character tiles 32 have all of the features of the alphanumeric character tiles 33 except, of course, the Braille character tiles 32 have raised tactile Braille characters 35 rather than alphanumeric characters. The Braille character tiles 32 are also slightly narrower than the alphanumeric character tiles 33, and the beveled edges 65 of the Braille character tiles 32 are on the right-hand end rather than the left-hand end of their tongue portions 64.

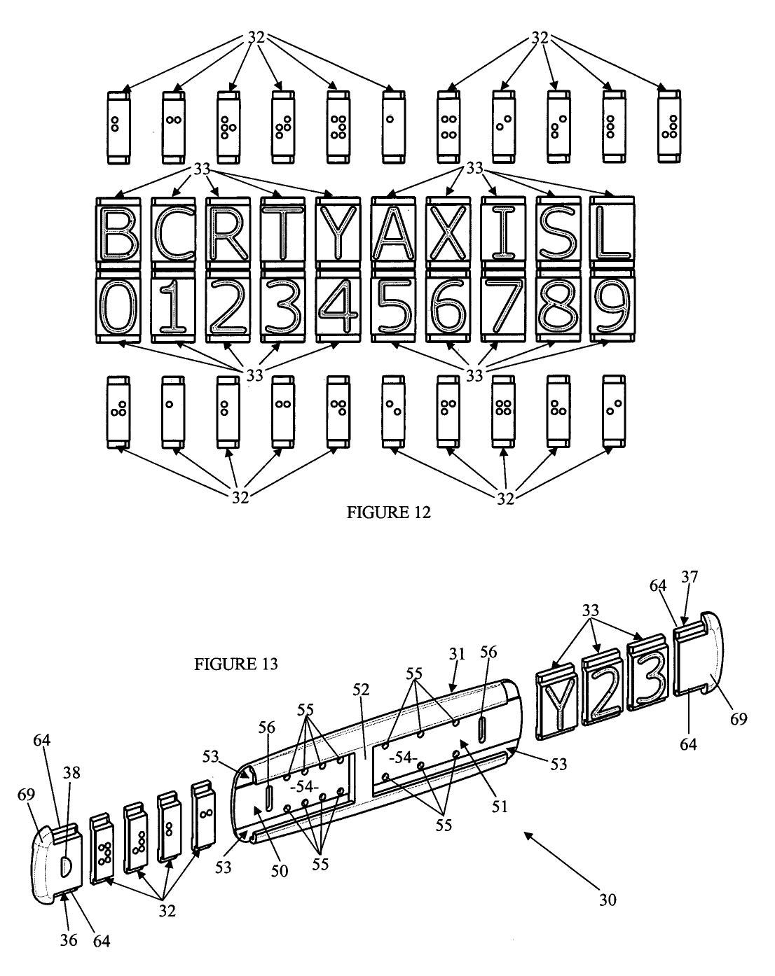

FIG. 12 depicts various character tiles 32, 33 that are able to be securely mounted on the baseplate 31 to produce a desired sign. The tiles 32, 33 may have characters or symbols which are not depicted in FIG. 12. The character tile 33 for the number “6” can also be used as the character tile 33 for the number “9”. Consequently, the tongue portions 64 of that tile 33 have beveled edges 65 on both their left-hand end and their right-hand end edges. Any combination or permutation of up to three alphanumeric character tiles 33, and any combination or permutation of up to four Braille character tiles 32 may be securely mounted on the baseplate 31. Also, more than one particular type of alphanumeric or Braille character tile 32, 33 may be mounted on the baseplate 31.

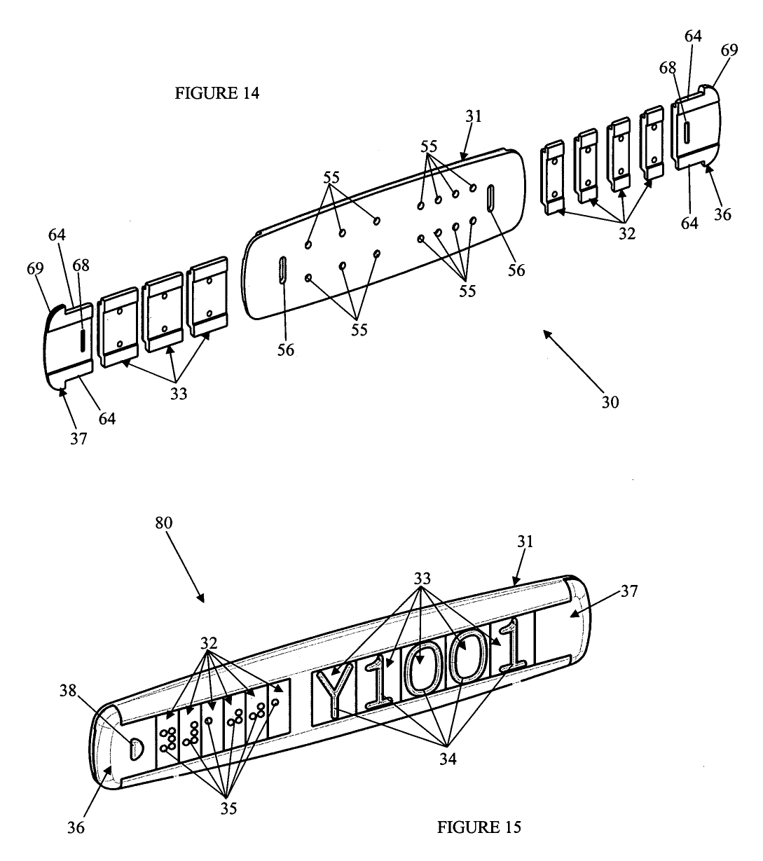

With reference to FIGS. 13 and 14, the Braille character tiles 32 of the sign 30 depicted in FIG. 1 are mounted on the baseplate 31 by sequentially sliding them into the recess 50. Each tile 32 is inserted into the left-hand end of the recess 50 so that each tongue portion 64 of each tile 32 is received by a respective groove 53 of the recess 50, and so that the Braille character 35 on the tile 32 faces away from the baseplate 31 and is correctly oriented relative to the baseplate 31 (i.e. is the right way up). The tile 32 is then slid along the recess 50 until the tile 32 abuts against either the separating portion 52 of the baseplate 31 or another tile 32 which was previously inserted into the recess 50. To assist in maintaining the tiles 32 in position, each locating projection 63 of each tile 32 is received by a respective locating aperture 55. The portions of the baseplate 31 which overlie the tiles 32, 33 force the locating projections 63 of the tiles 32, 33 into the locating apertures 55.

After all of the required Braille character tiles 32 have been inserted into the recess 50 and slid to the correct position along the recess 50, the retaining tile 36 is then inserted into the recess 50. The retaining tile 36 is similar to the character tiles 32, 33 except that it does not have circular locating projections 63. Instead, the retaining tile 36 has an elongate retaining tile locating projection 68 as depicted in FIG. 14. Also, unlike the character tiles 32, 33, the retaining tile 36 has an enlarged end portion 69. The retaining tile 36 is inserted into and slid along the recess 50 in a similar manner to the tiles 32 until its enlarged end portion 69 abuts against the baseplate 31. Upon reaching that position, the locating projection 68 of the tile 32 is received by the locating aperture 56 so that the locating projection 68 and the locating aperture 56 mechanically interlock with each other so that retaining tile 36 is retained in the recess 50. In particular, the portions of the baseplate 31 which overlie the tiles 36, 37 force the locating projections 68 into the locating apertures 56. Once the retaining tile 36 has been mounted on the baseplate 31, it is able to prevent the character tiles 32 from sliding out of the left-hand end of the recess 50.

The alphanumeric character tiles 33 of the sign 30 are mounted on the baseplate 31 in the same manner as described in connection with the character tiles 32. However, instead of being mounted in the recess 50, the tiles 33 are mounted in the recess 51. The tiles 33 are retained in the recess 51 by the retaining tile 37. The retaining tile 37 is identical to the retaining tile 36 except that it does not have a Braille locator 38.

The design of the individual tiles 32, 33, 36, 37 is such that they fit precisely into the baseplate 31 so that a mechanical fit occurs between the tiles 32, 33, 36, 37 and the baseplate 31, and so that the tiles 32, 33, 36, 37 are kept in place without having to use adhesives or specialist equipment such as, for example, sonic welding equipment.

To remove the character tiles 32, 33 from the baseplate 31, a screwdriver or other suitable implement must first be used to push the locating projections 68 out of the locating apertures 56 so that the retaining tiles 36, 37 can be removed from the baseplate 31 by sliding them out of the recesses 50, 51. Once the retaining tiles 36, 37 have been removed, the screwdriver or other implement is then used to push the locating projections 63 out of the locating apertures 55 so that the character tiles 32, 33 can be removed from the baseplate 31 by sliding them out of the recesses 50, 51.

The sign 30 may be attached to a support in any suitable manner. For example, double-sided adhesive tape may be used to secure the baseplate 31 to a support surface. The tape would typically be secured to the rear surface 57 of the baseplate 31 and to the support surface.

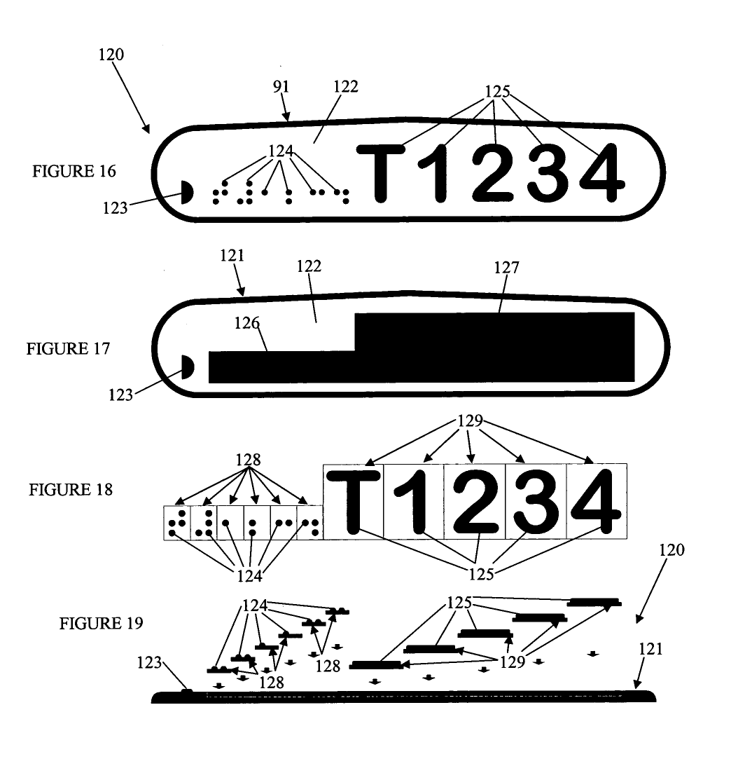

A tactile sign 80 according to a second preferred embodiment of the present invention is depicted in FIG. 15. For convenience, like features of the signs 30, 80 are referenced using the same reference numerals.

The tactile sign 80 is similar to the tactile sign 30 except that five alphanumeric character tiles 33 and six Braille character tiles 32 are able to be mounted on the baseplate 31 of the sign 80. The Braille characters 35 on the left-hand side of the sign 80 are equivalent to the alphanumeric characters 34 on the right-hand side of the sign 80.

FIG. 16 depicts a tactile sign 120 according to a third preferred embodiment of the present invention. The sign includes a baseplate 121 which has a flat and smooth front surface 122, and rounded corners. A Braille locator 123 extends from the front surface 122, and is located adjacent the left-hand end of the baseplate 121. A plurality of Braille and alphanumeric character tiles are mounted on the baseplate 121. Each Braille character tile has a single raised tactile Braille character 124, and each alphanumeric character tile has a single raised tactile alphanumeric character 125. The Braille characters 124 of the sign 120 are equivalent to the alphanumeric characters 125. Any desired combination or permutation of Braille and/or alphanumeric characters may be mounted on the baseplate 121.

FIG. 17 depicts the baseplate 121 without the character tiles mounted thereon. In addition to the features mentioned previously, the baseplate 121 also has a recess 126 for receiving the Braille character tiles, and a wider recess 127 for receiving the alphanumeric character tiles. The recesses 126, 127 are joined together.

The Braille character tiles 128 and the alphanumeric character tiles 129 which are mounted on the baseplate 121 are depicted in FIG. 18. FIG. 19 depicts how the character tiles 128, 129 are mounted on the baseplate 121, and also clearly shows that the characters 124, 125 are raised tactile characters. Each of the character tiles 128, 129 has a common base color, and a high luminance-contrast raised color for the characters 124, 125.

Before the sign 120 can be assembled, the desired Braille and alphanumeric character tiles 128, 129 are selected and are appropriately placed in the recesses 126, 127. The design of the tiles 128, 129 is such that the tiles 128, 129 interlock with each other when they are inserted into the recesses 126, 127 in such a way that ensures a tight, precise fit. The baseplate 121 and the tiles 128, 129 are then chemically welded together to produce the finished, flexible, solid plastic tactile sign 120. The finished sign 120 has no edges or gaps which would allow the tiles 128, 129 to be lifted and removed from the baseplate 121.

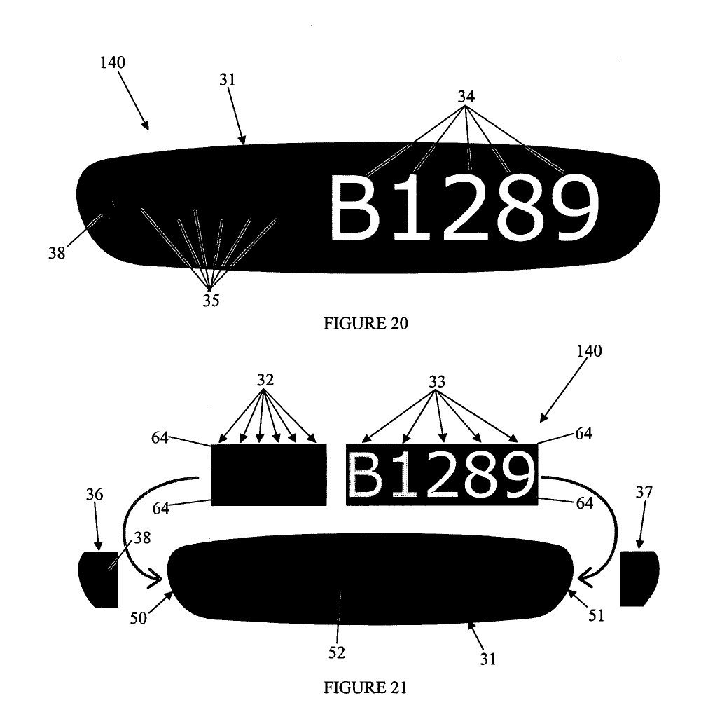

FIG. 20 depicts a tactile sign 140 according to a fourth preferred embodiment of the present invention. The sign 140 is similar to the sign 80. Therefore, for convenience, like features of the signs 80 and 140 are referenced using the same reference numerals.

The most significant difference between the two signs 80, 140 is that the retaining tiles 36, 37 of the sign 140 do not have enlarged end portions 69. The various components of the sign 140 are sonically welded together to produce the single-piece sign 140.

The various components of the tactile signs described herein are preferably made using a solid plastic injection molding process. The various components may be fabricated from any suitable plastic. For example, the components may be fabricated from pre-made laminates or cast acrylics which are used in the engraving and sign industries. Alternatively, the components may be fabricated from plastics which are not commonly used in the engraving and sign industries. The plastic from which the components are fabricated is preferably a flexible plastic.

The process of fabricating the various components of the sign preferably involves the use of specific tooling and molding procedures to ensure that each character tile will have a precise fit with the baseplate of the sign without shrinkage or warping occurring.

The color of the characters or symbols of the character tiles preferably contrasts with the base color of the other parts of the character tiles. This color contrast may be achieved, for example, by co-molding, over-molding or doubled-shot molding the contrasting color through the base color of the tile. The process of co-molding, over-molding or doubled-shot molding is able to provide a solid color contrast of the characters into the base color of the injection molded portion of the character tiles.

The various components of the tactile signs may be molded to PMS (Pantone Matching System) colors if required.

The tactile signs may be interiorly or exteriorly mounted using double-sided adhesive tape or any other suitable securing means.

The tactile sign is particularly suitable for use in public buildings and in relation to public transportation. In particular, the tactile sign is particularly suitable for use in situations where signs are required for the display of numbers such as, for example, door or seat numbers, or for the display of individualized information such as, for example, directory board information.

Throughout the specification and the claims, unless the context requires otherwise, the term “comprise”, or variations such as “comprises” or “comprising”, will be understood to apply the inclusion of the stated integer or group of integers but not the exclusion of any other integer or group of integers.

Throughout the specification and claims, unless the context requires otherwise, the term “substantially” or “about” will be understood to not be limited to the value for the range qualified by the terms.

It will be appreciated by those skilled in the art that variations and modifications to the invention described herein will be apparent without departing from the spirit and scope thereof. The variations and modifications as would be apparent to persons skilled in the art are deemed to fall within the broad scope and ambit of the invention as herein set forth.

It will be clearly understood that, if a prior art publication is referred to herein, that reference does not constitute an admission that the publication forms part of the common general knowledge in the art in Australia or in any other country.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-17. (canceled)

18. A tactile sign comprising a baseplate, a character tile able to be securely mounted on the baseplate, the character tile including a raised tactile character, a tongue portion, and a locating projection, and the baseplate including a recess for receiving the character tile, a groove for receiving the tongue portion, and a locating aperture for receiving the locating projection.

19. The tactile sign of claim 18, wherein the baseplate is molded.

20. The tactile sign of claim 18, wherein the baseplate is extruded.

21. The tactile sign of claim 18, wherein the recess extends from an end of the baseplate so that the character tile is able to be slideably inserted into and slideably removed from an end of the recess.

22. The tactile sign of claim 21, wherein the tactile sign further comprises a retaining tile for preventing the character tile from being removed from the end of the recess.

23. The tactile sign of claim 22, wherein the retaining tile includes a tongue portion for insertion into the groove of the baseplate, and a retaining tile locating projection, and the baseplate further includes a retaining tile locating aperture for receiving the retaining tile locating projection.

24. The tactile sign of claim 23, wherein the retaining tile locating projection is able to be received by the retaining tile locating aperture such that the retaining tile locating projection and the retaining tile locating aperture mechanically interlock with each other to inhibit removal of the retaining tile from the recess.

25. The tactile sign of claim 22, wherein the retaining tile includes an enlarged end portion for abutting against the baseplate.

26. The tactile sign of claim 22, wherein the retaining tile includes a Braille locator.

27. The tactile sign of claim 18, wherein the character tile is molded.

28. The tactile sign of claim 18, wherein the character tile is manufactured as a one-piece unit.

29. The tactile sign of claim 18, wherein the character tile includes a main portion, and a pair of the tongue portions extending from the main portion.

30. The tactile sign of claim 29, wherein the tongue portions are offset with respect to the main portion.

31. The tactile sign of claim 29, wherein each of the tongue portions has at least one beveled edge.

32. The tactile sign of claim 18, wherein the character tile is tapered.

33. The tactile sign of claim 18, wherein the raised tactile character is a Braille character or an alphanumeric character.

34. The tactile sign of claim 18, wherein the raised tactile character is co-molded, over-molded or doubled-shot molded with the rest of the character tile.
